(19) United States
(12) Patent Application Publication
(10) Pub. No.: US 2013/0115469 A1
(43) Pub. Date: May 9, 2013

(54) CURABLE RESIN COMPOSITION FOR HARD COAT LAYER, METHOD FOR PRODUCING HARD COAT FILM, HARD COAT FILM, POLARIZING PLATE AND DISPLAY PANEL

(71) Applicants: Yusuke Hayashi, Tokyo-to (JP); Tomoyuki Horio, Tokyo-to (JP); Seiji Shinohara, Tokyo-to (JP)

(72) Inventors: Yusuke Hayashi, Tokyo-to (JP); Tomoyuki Horio, Tokyo-to (JP); Seiji Shinohara, Tokyo-to (JP)

(73) Assignee: DAI NIPPON PRINTING CO., LTD., Tokyo-to (JP)

(21) Appl. No.: 13/809,959

(22) PCT Filed: Aug. 4, 2011
(86) PCT No.: PCT/JP2011/067882

§ 371 Date: Jan. 14, 2013

(30) Foreign Application Priority Data
Aug. 6, 2010 (JP) 2010-177149

(51) Int. Cl. C09D 7/12; B32B 23/08; G02B 5/30

(52) U.S. Cl. CPC C09D 7/1275; G02B 5/30; B32B 23/08
USPC 428/452; 524/770; 427/508; 359/492.01

(57) ABSTRACT

Disclosed is a hard coat film having high hardness, sufficient anti-blocking property, low haze, and high total light transmittance. A curable resin composition for a hard coat layer comprises: (A) reactive silica particle with a photocurable group on the surface and average primary particle diameter of 10 to 100 nm, (B) slipping agent with average primary particle diameter of 100 to 300 nm, (C) secondary particle containing agent (B) with average secondary particle diameter of 500 to 2,000 nm, (D) multifunctional monomer with molecular weight of 1,000 or less having, in a molecule, two or more reactive functional groups crosslinkable with the photocurable group of particle (A), and (E) solvent, the composition containing no secondary particle with average secondary particle diameter more than 2,000 nm, and 0.2 to 8% by mass of agent (B) to the total mass of particle (A) and monomer (D).

### TECHNICAL FIELD

The present invention is related to hard coat films provided on the foreface of displays (image displays) such as liquid crystal displays (LCD), cathode-ray tube displays (CRT), plasma displays (PDP), electronic papers, LEDs, touch panels, or tablet PCs to protect the display surface of these displays, curable resin compositions suitable for forming hard coat layers of the hard coat films, methods for producing the hard coat films, polarizing plates and display panels provided with the hard coat films.

### BACKGROUND ART

It is required to impart abrasion resistance and hardness to the image display surface of displays in order to avoid damages while handling. Generally, HC films comprising a triacetyl cellulose substrate and a hard coat layer provided thereon, or optical films further imparted with optical functions such as anti-reflection properties, anti-glare properties, etc. are utilized to improve the abrasion resistance and hardness of image display surface of displays. Hereinafter, triacetyl cellulose may be referred as “TAC”, and hard coat may be referred as “HC”.

Conventionally, addition of particles other than resins has been known to improve the hardness of hard coat films since the uses of material increasing hardness of resin itself tends to worsen curl (curving of films). It is preferable to use silica as such particles taking haze and transmittance into consideration. In addition, the hardness further improves when reactive silica, which is a silica particle having reactive groups imparted around the silica particle, is used.

If any concavo-convex defect is present on the surface of a HC layer of a clear HC film with a flat facemost, when something hard contacts the HC layer, it is caught by the convex portion applying excessive force, thereby, fine damage may be caused. Therefore, it is effective to smoothen the surface of the HC layer in order to improve the abrasion resistance of the surface of the HC layer.

However, when a HC film, the surface of which is very smooth, is consecutively wound in the state of continuous belt to form a long continuous roll or layered, the HC layer side surface of the HC film may stick to the substrate film side surface of the HC film just like adhering mirror planes, which is so called blocking phenomenon. Blocking causes problems such as HC films being torn when the HC film roll is released upon production of products, etc.

To solve such a problem, there is a method proposed that particles (slipping agent) having an average primary particle diameter of 300 nm or less are contained in a HC layer to form minute protrusions having sizes not damaging the smoothness of the surface on one or both of adhering surfaces, thereby imparting anti-blocking property (hereinafter, it may be referred to as “slipperiness”) to a HC film (for example, Patent Literatures 1 and 2).

In this case, if a slipping agent having a large average primary particle diameter is contained in the HC layer, the anti-blocking property can be easily exhibited by the fine small protrusion shapes formed on the surface of the HC layer. However, the optical properties of the HC film decrease such as increase in haze and decrease in total light transmittance of the HC film.

If a slipping agent having smaller average primary particle diameter is contained in the HC layer to prevent increase in haze, etc., however, sufficient convexo-concave shapes cannot be formed, thus, the anti-blocking property may be insufficient.

Hence, a hard coat film satisfying all of high hardness, sufficient anti-blocking property, low haze, and high total light transmittance has been required.

### CITATION LIST

### Patent Literatures

[Patent Literature 1] Japanese Patent Application Laid-open (JP-A) No. 2009-035614
[Patent Literature 2] JP-A No. 2009-132880

### SUMMARY OF INVENTION

### Technical Problem

The inventors of the present invention have presumed that mixing the aforementioned slipping agent and reactive silica may solve such problems. However, simply adding particles such as the slipping agent, reactive silica, etc. in a matrix resin has not been able to exhibit aimed physical properties (slipperiness and both physical properties and optical properties).

For example, even when a slipping agent compatible with an ink containing reactive silica is mixed, small protrusions have not been sufficiently formed on the surface of a film, since the particles uniformly disperse upon forming the film. Even in the case of a dispersant containing an adequately-adjusted slipping agent, small protrusions have not been sufficiently formed on the surface of a film, since the slipping agent which is smaller than reactive silica has been buried in the reactive silica. If the slipping agent is excessively larger than the reactive silica, haze increases and transmittance decreases.

The inventors of the present invention have found out that there is an adequate amount and size of slipping agent, and also have found out a method for producing particles usable as the slipping agent having an adequate size.

The present invention has been achieved to solve the above-stated problems. The first object of the present invention is to provide a hard coat film having high hardness, sufficient anti-blocking property, low haze, and high total light transmittance.

The second object of the present invention is to provide a curable resin composition for a HC layer suitable for forming a HC layer of the HC film.

The third object of the present invention is to provide a method for producing the HC film.

The fourth object of the present invention is to provide a polarizing plate provided with the HC film.

The fifth object of the present invention is to provide a display panel provided with the HC film.

### Solution to Problem

As a result of diligent researches, the inventors of the present invention have found out that instead of using only slipping agent having a specific average primary particle diameter to form small protrusion shapes on the surface, a curable resin composition comprising secondary particles having a specific particle diameter containing at least the slipping agent is used to form a HC layer, thereby, while the HC layer formed has sufficient anti-blocking property, increase in haze and decrease in total light transmittance of a HC film can be prevented, and a hard coat film having high hardness can be obtained. Based on the above knowledge, the inventors have reached the present invention.

That is, a curable resin composition for a hard coat layer of the present invention comprises:

(A) a reactive silica particle having a photocurable group on a surface of the particle and an average primary particle diameter of 10 to 100 nm,

(B) a slipping agent having an average primary particle diameter of 100 to 300 nm,

(C) a secondary particle at least comprising the slipping agent (B) and having an average secondary particle diameter of 500 to 2,000 nm,

(D) a multifunctional monomer having, in a molecule, two or more reactive functional groups crosslinkable with the photocurable group of the reactive silica particle (A) and having a molecular weight of 1,000 or less, and

(E) a solvent,

wherein the resin composition contains no secondary particle having an average secondary particle diameter of more than 2,000 nm, and contains 0.2 to 8% by mass of the slipping agent (B) with respect to the total mass of the reactive silica particle (A) and the multifunctional monomer (D).

Since the slipping agent (B) is contained at the aforementioned specific ratio, the secondary particle (C) contains at least the slipping agent (B), and the average secondary particle diameter of the secondary particles (C) is from 500 to 2,000 nm, fine small protrusion shapes exhibiting anti-blocking property are formed on the surface of a hard coat layer upon curing the curable resin composition for the hard coat layer. It is presumed that primary particles also contribute to blocking (improve anti-blocking property) in a small extent. Basically, the HC film has a smooth surface and is clear, but small protrusions of nano order which are invisible to the eye are present on the smooth surface at intervals of 6,000 nm or less.

It is preferable that the secondary particle (C) contains a three-components-aggregated secondary particle, in which at least the reactive silica (A), the slipping agent (B) and the multifunctional monomer (D) are aggregated, since increase in haze and decrease in total light transmittance of the HC film can be further prevented, and a hard coat film having high hardness can be obtained.

In the curable resin composition for a hard coat layer of the present invention, it is preferable that the solvent (E) is at least one kind selected from the group consisting of methyl acetate, ethyl acetate, butyl acetate, methyl ethyl ketone, methyl isobutyl ketone and cyclohexanone since fine small protrusion shapes are easily formed on the surface of the HC layer upon curing. These solvents are penetrable with substrates and cause increase in concentration of solid content in the ink on the substrate, thus, the fine small protrusion shapes are easily formed. Therefore, the necessary amount of particles added becomes small, and a HC layer having no increase in haze and decrease in transmittance can be obtained.

A method for producing a hard coat film of the present invention comprises the steps of:

(i) applying the curable resin composition for a hard coat layer on a triacetyl cellulose substrate to form a coating layer, and

(ii) curing the coating layer by light irradiation to form the hard coat layer.

It is preferable to prepare the curable resin composition for the hard coat layer according to the following steps from the viewpoint of forming the secondary particle having an appropriate secondary particle diameter:

(1) mixing a composition comprising at least the reactive silica (A), the multifunctional monomer (D) and the solvent (E) to prepare Ink 1,

(2) mixing a composition comprising at least the slipping agent (B) and the solvent (E) to prepare Ink 2, and

(3) forming the secondary particle (C) by gradually mixing said Ink 2 into said Ink 1 while stirring said Ink 1 to prepare the curable resin composition for the hard coat layer.

In the method for producing the hard coat film of the present invention, it is preferable that the curable resin composition for the hard coat layer is applied on the substrate within 24 hours after completing preparation of the curable resin composition from the viewpoint of keeping the average secondary particle diameter within the preferable range.

A hard coat film of the present invention is produced according to the aforementioned method.

A polarizing plate of the present invention comprises the hard coat film, and a polarizer provided on a triacetyl cellulose substrate side of the hard coat film.

A display panel of the present invention comprises the hard coat film, and a display provided on a triacetyl cellulose substrate side of the hard coat film.

### Advantageous Effects of Invention

The hard coat film according to the present invention has high hardness, sufficient anti-blocking property, low haze, and high total light transmittance.

The curable resin composition for the hard coat layer of the present invention can be suitably used for forming the hard coat layer having the aforementioned properties.

According to the method for producing the hard coat film of the present invention, the hard coat film can be easily produced.

### BRIEF DESCRIPTION OF DRAWINGS

FIG. 1 is a view schematically showing an example of the method for producing the hard coat film of the present invention.

FIG. 2 is a view schematically showing an example of a layer structure of the hard coat film of the present invention.

FIG. 3 is a view schematically showing another example of a layer structure of the hard coat film of the present invention.

FIG. 4 is a view schematically showing an example of a layer structure of the polarizing plate of the present invention.

FIG. 5 is a graph showing the relationship between particle diameters and scattering intensity distribution of the curable resin composition for the hard coat layer of Example 1.

FIG. 6 is a graph showing the relationship between particle diameters and scattering intensity distribution of the curable resin composition for the hard coat layer of Comparative example 2.

FIG. 7 is a graph showing the relationship between particle diameters and scattering intensity distribution of the curable resin composition for the hard coat layer of Comparative example 7.

FIG. 8 is a STEM (Scanning Transmission Electron Microscope) photograph of a section view of a hard coat layer of the present invention at a magnification of 50,000 times. The embedding layer in the photograph is an embedding resin layer formed when a hard coat film is embedded in a resin to hold the film stably and cut in section by means of a microtome.

### DESCRIPTION OF EMBODIMENTS

Hereinafter, the curable resin composition for the hard coat layer, hard coat film, method for producing the hard coat film, polarizing plate and display panel of the present invention will be explained.

In the present invention, (meth)acrylate means acrylate and/or methacrylate.

In the present invention, “light” includes not only electromagnetic waves having a wavelength in the visible region and those having a wavelength in the nonvisible region but also particle beams (e.g. electron beams) and radiation or ionizing radiation, which is a general term for electromagnetic waves and particle beams.

In the present invention, “hard coat layer” means a layer which has a hardness of “H” or more on the pencil hardness test with a load of 4.9 N defined in JIS K5600-5-4 (1999).

High hardness means hardness of “3H” or more.

Solid content means components other than a solvent(s).

In the definition of a film and sheet in JIS-K6900, a sheet means a thin and flat product in which generally the thickness of the sheet is relatively thin considering the length and width thereof, and a film means a thin and flat product in which the thickness of the film is significantly thin compared with the length and width thereof and the maximum thickness is arbitrarily limited, generally provided in a form of a roll. Therefore, it can be said that a sheet having a particularly thin thickness among sheets is a film. However, the boundary between sheets and films is unclear and it is difficult to precisely distinguish the difference between sheets and films. Accordingly, in the present invention, the definition of “film” includes both one having a thick thickness and one having a thin thickness.

In the present invention, “resin” is a concept including monomers, oligomers and polymers, and means a component which becomes a matrix of a HC layer or other functional layers after curing.

In the present invention, “molecular weight” means a polystyrene-equivalent weight average molecular weight measured by gel permeation chromatography (GPC) using a THF solvent in the case where a compound has a molecular weight distribution. In the case where a compound has no molecular weight distribution, “molecular weight” means the molecular weight of the compound itself.

In the present invention, “average particle diameter of particle(s)” means a mode diameter (a particle diameter, in which the scattering intensity distribution is maximum) measured by dynamic light scattering by means of FPAR-1000 (product name; manufactured by: Otsuka Electronics Co., Ltd.) in the case of particles in a composition, and means an averaged value of diameters of aimed 10 particles of silica or slipping agent in the cross-sectional surface of a cured film observed in a scanning transmission electron microscope (STEM) image in the case of particles in a cured film.

Each of the average primary particle diameter of the reactive silica particles (A) and the average primary particle diameter of the slipping agent (B) in the present invention means a mode diameter (nm) measured by means of the aforementioned device without diluting Ink 1 and Ink 2. The average secondary particle diameter of the secondary particles (C) means a mode diameter (m, μm) measured by means of the aforementioned device without diluting the curable resin composition for the hard coat layer (solvent+resin+reactive silica+slipping agent).

A primary particle means a particle having an average primary particle diameter when a unit particle is measured in the aforementioned measuring method.

A secondary particle means not only a particle simply formed with primary particles adhering to each other, being aggregated and having high density but also a particle formed with particles and a resin(s) present therebetween and being aggregated in this state. It is presumed that the latter has more effect on scratch resistance (abrasion resistance) in the present invention. The aggregated particles having an average secondary particle diameter obtained by the aforementioned measuring method without diluting the curable resin composition for the hard coat layer are regarded as a secondary particle.

### (Curable Resin Composition for Hard Coat Layer)

The curable resin composition for a hard coat layer of the present invention (hereinafter, it may be simply referred as “the composition for a HC layer”) comprises:

(A) a reactive silica particle having a photocurable group on a surface of the particle and an average primary particle diameter of 10 to 100 nm,

(B) a slipping agent having an average primary particle diameter of 100 to 300 nm,

(C) a secondary particle at least comprising the slipping agent (B) and having an average secondary particle diameter of 500 to 2,000 nm,

(D) a multifunctional monomer having, in a molecule, two or more reactive functional groups crosslinkable with the photocurable group of the reactive silica particle (A) and having a molecular weight of 1,000 or less, and

(E) a solvent,

wherein the resin composition contains no secondary particle having an average secondary particle diameter of more than 2,000 nm, and contains 0.2 to 8% by mass of the slipping agent (B) with respect to the total mass of the reactive silica particle (A) and the multifunctional monomer (D).

It is known to add particles other than resins to improve hardness of hard coat films since curl (films make curvature deformation) tends to worsen if materials increasing the hardness of the resins themselves are used. As such particles, the reactive silica (A) is used. Since the silica can keep haze and transmittance excellent and has a reactive group(s), it can further improve hardness by reacting and crosslinking with the matrix resin of the hard coat layer.

Since the slipping agent (B) is contained in the above specific ratio, the secondary particle (C) is contained, and the average secondary particle diameter of the secondary particles (C) is from 500 nm to 2,000 nm, fine small protrusion shapes exhibiting the anti-blocking property are formed on the surface of the HC layer upon curing the curable resin composition for the hard coat layer.

Since the curable resin composition for the HC layer does not contain a secondary particle having an average secondary particle diameter of greater than 2,000 nm, the HC layer, which is a cured curable resin composition for the HC layer, has low haze and high total light transmittance.

Hereinafter, the essential components of the curable resin composition for the hard coat layer of the present invention, (A) reactive silica particle, (B) slipping agent, (C) secondary particle, (D) multifunctional monomer and (E) solvent, and other components which may be accordingly contained if necessary will be explained in this order.

### (Reactive Silica Particle (A))

The reactive silica particle (A) is a component imparting hardness to a HC layer. The photocurable group on the surface of the reactive silica particle (A) can polymerize or crosslink with the reactive functional group of the multifunctional monomer (D) hereinafter described when the curable resin composition for the HC layer is cured by light such as ultraviolet rays etc.

The photocurable group of the reactive silica particle (A) may be any group capable of reacting with the reactive functional group of the multifunctional monomer by light. The photocurable group is preferably a polymerizable unsaturated group, more preferably an ionizing radiation-curable unsaturated group. Specific examples thereof include ethylenically unsaturated bonds such as a (meth)acryloyl group, a (meth)acryloyloxy group, a vinyl group and an allyl group, and an epoxy group. The photocurable group is preferably a methacryloyl group or a methacryloyloxy group.

As the reactive silica particle (A), any of conventionally-known reactive silica particles may be used, for example, reactive silica particles disclosed in JP-A No. 2008-165040. Specifically, examples include: MIBK-SD (average primary particle diameter: 12 nm), MIBK-SDMS (average primary particle diameter: 20 nm) and MIBK-SDUP (average primary particle diameter: 9-15 nm; chain) (product names; manufactured by: Nissan Chemical Industries, Ltd.); ELCOM DP1116SIV (average primary particle diameter: 12 nm), ELCOM DP1129SIV (average primary particle diameter: 7 nm), ELCOM DP1061SIV (average primary particle diameter: 12 nm), ELCOM DP1050SIV (average primary particle diameter: 12 nm; fluorine coat), ELCOM DP1037SIV (average primary particle diameter: 12 nm) and ELCOM DP1026SIV (average primary particle diameter: 12 nm; alumina coat) (product names; manufactured by: JGC Catalysts and Chemicals Ltd.); BEAMSET LB1 (average primary particle diameter: 20 nm), BEAMSET 904 (average primary particle diameter: 20 nm) and BEAMSET 907 (average primary particle diameter: 20 nm) (product names; manufactured by: Arakawa Chemical Industries, Ltd.); and MIBK-SDL (product name; manufactured by: Nissan Chemical Industries, Ltd.; average primary particle diameter: 44 nm). Among the above, suitably used examples include MIBK-SD (average primary particle diameter: 12 nm) and MIRK-SDL (average primary particle diameter: 44 nm) (product names; manufactured by: Nissan Chemical Industries, Ltd.); and ELCOM DP1129SIV (average primary particle diameter: 7 nm), ELCOM DP1050SIV (average primary particle diameter: 12 nm; fluorine coat), ELCOM DP1026SIV (average primary particle diameter: 12 nm; alumina coat), ELCOM DP1116SIV (average primary particle diameter: 10 nm), and ELCOM DP-1119SIV (average primary particle diameter: 100 nm) (product names; manufactured by JGC Catalysts and Chemicals Ltd.) having a preferable photocurable group.

The shape of the silica particle may be, for example, spherical, approximate spherical, an elliptical shape or an indeterminate shape.

The average primary particle diameter of the reactive silica particles (A) is from 10 to 100 nm. If the average primary particle diameter is less than 10 nm, a sufficient hardness may not be imparted to the HC layer. If the average primary particle diameter thereof exceeds 100 nm, the haze of the HC layer increases and transparency decreases.

The reactive silica particles (A) may be of one kind having a single average primary particle diameter, or two or more kinds having different average primary particle diameter used in combination if the average primary particle diameter is from 10 to 100 nm. The photocurable group, shape, etc. of the reactive silica particles (A) may be the same or different from each other.

The content of the reactive silica particle (A) is preferably from 30 to 70% by mass, more preferably from 40 to 60% by mass, with respect to the total mass of the multifunctional monomer (D) hereinafter described. If the content of the reactive silica particle (A) is not sufficient, a hard coat film having high hardness cannot be obtained, in most cases, the hard coat film becomes friable.

The reactive silica particles (A) are contained in the secondary particle (C) and contribute to the formation of the three-components-aggregated secondary particle having a particle diameter larger than that of the slipping agent (B) and exhibiting high anti-blocking property as hereinafter described.

### (Slipping Agent (B))

The slipping agent (B) is a particle(s) having an average primary particle diameter of 100 to 300 nm contributing to the formation of fine concavo-convex shapes for exhibiting the anti-blocking property of the surface of the HC layer.

The slipping agent (B) is contained in the secondary particle (C) and contributes to the formation of the three-components-aggregated secondary particle having a particle diameter larger than that of the slipping agent (B) and exhibiting high anti-blocking property as hereinafter described.

If the average primary particle diameter of the slipping agent (B) particles is less than 100 nm, the slipping agent (B) particles are buried in the reactive silica particles (A) and it is less likely that the particles aggregate. Hence, sufficient anti-blocking property cannot be exhibited. If the average primary particle diameter of the slipping agent (B) particles exceeds 300 nm, the transparency of the HC layer decreases and the haze increases.

As the slipping agent (B), for example, organic silicone particles having an average primary particle diameter of 300 nm or less disclosed in Patent Literature 1, or hydrophilic particles (silica particles) having an average primary particle diameter of 100 to 300 nm disclosed in Patent Literature 2 may be used. The organic silicone particle means a polymer compound (polymer particle) having an organic group with a backbone of a siloxane bond, etc. Examples of the organic group include a hydrocarbon group with or without heteroatom, and also a polyether group, a polyester group, an acrylic group, an urethane group, and an epoxy group. The shape of the organic silicone particle may be approximately spherical, for example, spherical, spheroidal, etc., and is preferably spherical. The shape of the hydrophilic particle (silica particle) may not be particularly limited. The shape of the hydrophilic particle is preferably approximately spherical such as elliptical or spherical since there is no angular part, which causes diffusion of reflected light, etc., and haze is less caused.

It is preferable that a slipping agent (B) that is hydrophilic or one having hydrophilicity imparted by a surface preparation agent is used. When the hydrophilic slipping agent (B) particles are present in a hydrophobic hard coat resin, the slipping agent particles are likely to float at the air interface where moisture is present, that is, the surface of the hard coat layer, and also the secondary particle can be efficiently formed. However, if the hydrophilic slipping agent (B) particles are unevenly distributed, the three-components-aggregated secondary particles hereinafter described are not formed together with the hydrophobic hard coat resin and the hydrophobically-treated reactive silica particles, but many secondary particles formed of slipping agent (B) particles alone are formed. Thus, preferable anti-blocking property cannot be obtained. Therefore, a dispersant is added in order to disperse the hydrophilic slipping agent (B) particles in the hydrophobic hard coat resin, and to form the three-components-aggregated secondary particles.

A preferable dispersant may not be particularly limited if it is used for solvents or ionizing radiation-curable binders.

Examples of anionic dispersants (anionic surfactants) include N-acyl-N-alkyltaurin salts, fatty acid salts, alkyl sulfates, alkylbenzene sulfonates, anionic sulfonates, alkylnaphthalene sulfonates, dialkyl sulfosuccinates, and alkyl phosphates; formalin naphthalenesulfonate condensates; and polyoxyethylene alkyl sulfates. These anionic dispersants may be used alone or in a combination of two or more kinds.

Examples of cationic dispersants (cationic surfactants) include quaternary ammonium salts, alkoxylated polyamines, aliphatic amine polyglycol ethers, aliphatic amines, diamines and polyamines derived from aliphatic amines and aliphatic alcohols, imidazolines derived from fatty acids and salts of cationic material thereof. These cationic dispersants may be used alone or in a combination of two or more kinds.

Zwitterionic dispersants are dispersants having, in a molecule, an anionic group moiety present in a molecule of the anionic dispersant and a cationic group moiety present in a molecule of the cationic dispersant.

Examples of nonionic dispersants (nonionic surfactants) include polyoxyethylene alkyl ethers, polyoxyethylene alkyl aryl ethers, polyoxyethylene fatty acid esters, sorbitan fatty acid esters, polyoxyethylene sorbitan fatty acid esters, polyoxyethylene alkyl amines, and glycerin fatty acid esters. Among the above, polyoxyethylene alkyl aryl ethers are preferable. These nonionic dispersants may be used alone or in a combination of two or more kinds.

Since the dispersant does not function as a binder, it may hinder curing if it is added excessively. A dispersant having excessively high molecular weight is less compatible with a binder. Hence, a dispersant preferably used is a compound having a number average molecular weight of 2,000 to 20,000 and exhibiting its effect in a small amount when added. Specific examples thereof include anionic dispersants (product names: DISPERBYK-163, DISPERBYK-170 and DISPERBYK-183; manufactured by: BYK-Chemie Japan KK).

Examples of commercially available hydrophilically-treated organic silicone particles include PIONIN series (product name; manufactured by: Takemoto Oil & Fat Co., Ltd.).

Examples of commercially available hydrophilic particles include SIRMEK-E03 (product name; manufactured by: CIK NANOTECH CO. LTD.) and IPA-ST-ZL (product name; manufactured by: Nissan Chemical Industries, Ltd.).

The slipping agent (B) may be one kind of particles having a single average primary particle diameter, or two or more kinds of particles having different average primary particle diameters in combination, if the average primary particle diameter is from 100 to 300 nm. In the case of using two or more kinds of slipping agent (B) particles in combination, the material, shape, etc. thereof may be the same or different.

The content of the slipping agent (B) is from 0.2 to 8% by mass, preferably from 1 to 5% by mass, with respect to the total mass of the reactive silica particles (A) and the multifunctional monomer (D).

### (Secondary Particle (C))

The secondary particle (C) is a component contributing to the formation of fine small protrusion shapes on the surface of the HC layer, that is, imparting of the anti-blocking property to the HC layer upon curing the curable resin composition for the HC layer.

The secondary particle (C) at least contains the slipping agent (B), and the average secondary particle diameter of the secondary particles (C) is from 500 nm to 2,000 nm. If the average secondary particle diameter of the secondary particles (C) is less than 500 nm, a sufficient anti-blocking property may be not imparted to the HC layer. If the average secondary particle diameter of the secondary particles (C) exceeds 2,000 nm, the aggregation may be unstable and the transparency of the HC layer may be impaired.

The secondary particle (C) may be a secondary particle formed of aggregated slipping agent (B) particles, or the three-components-aggregated secondary particle formed of the slipping agent (B) particles, the reactive silica particles (A) and the multifunctional monomer (D) being aggregated. Hence, the particle diameters of the secondary particles may be a single particle diameter or may be of plural different particle diameters.

The reason why the secondary particles need to be formed is as follows. For example, if the reactive silica particles (A) alone are used, small protrusions in an amount sufficient to exhibit slipperiness cannot be formed since the reactive silica particles (A) have good dispersibility and uniformly disperse upon forming a film. However, if the slipping agent (B) particles are added to form secondary particles, small protrusions capable of exhibiting slipperiness can be formed on the surface of the HC layer.

It is presumed that if the reactive silica particles (A) and the slipping agent (B) particles are present, the secondary particles comprising the reactive silica particles (A) and the slipping agent (B) particles are naturally formed. In fact, when they are mixed, such secondary particles are confirmed. However, such secondary particles alone cannot realize a HC film having low haze, high transparency and anti-blocking property. It is important that the three-components-aggregated secondary particles (such as particles of photograph in FIG. 8) formed of the reactive silica particles (A), the slipping agent (B) particles and the multifunctional monomer (D) being aggregated are present on the surface of the HC layer in an appropriate amount.

Also, the average secondary particle diameter of the secondary particles is important. If the reactive silica particles (A) and the slipping agent (B) particles do not have the average primary particle diameters within their specific ranges respectively, the three-components-aggregated secondary particles formed cannot have not only optimal particle diameters but also optimal shapes. For example, in the case that the average primary particle diameter of the reactive silica particles (A) and/or slipping agent (B) particles is excessively large, the three-components-aggregated secondary particle may seem to have a preferable size, but the shape of the aggregate tends to be in the condition that there are many angle components, which may cause increase in haze and decrease in transmittance. Herein, the “angle component” means an acute moiety (convex shape) of convexo-concave shapes formed on the surface of an aggregate when two large particles closely adhere to each other to form the aggregate.

If small particles form an aggregate, spaces in the whole aggregate are filled by small particles. As the result, the aggregate itself becomes a round form so that there are not many angle components. If large particles form an aggregate having the same particle diameter as the aggregate formed by small particles, spaces in the whole aggregate are not filled by large particles so that the aggregate cannot be round and forms a shape that particles are somewhat protruding (the surface of the aggregate is in the condition of convexo-concave shape). If the outline of the aggregate is approximately round, there is less opportunity that light is diffused. If the aggregate is in the convexo-concave shape, there are many acute moieties so that the angular size that diffuses reflected light or incident light becomes large, which may cause increase in haze and decrease in transmittance.

In addition, for example, even if large particles having the same size as the secondary particle or the three-components-aggregated secondary particle and the same refractive index as the binder are added, the same effect as the present invention cannot be obtained, and while the anti-blocking property can be exhibited, the optical properties may worsen. Thus, even though the heights of the small protrusion shapes formed on the surface of the HC layers are the same, the light diffusion property increases and causes whitening, since the small protrusion shapes are steep.

Upon forming the secondary particles, the average secondary particle diameter is controlled by the particle diameter and amount added of the slipping agent (B). The more slipping agent (B) is added, the larger the particle diameter of the secondary particle becomes.

The mechanism of aggregation of particles is presumed as follows. Generally, hydrophilically-processed particles (slipping agent (B)) tend to aggregate in a hydrophobic binder matrix and to tend float to the surface direction of the HC layer where moisture in the air is present. The hydrophilically-processed particles (slipping agent (B)) can appropriately be dispersed in the hydrophobic resin (HC matrix component) by the dispersant. Since the reactive group of the reactive silica (A) is hydrophobic, the reactive silica (A) easily mixes and bonds with the HC matrix component. Since silica itself is hydrophilic, the silica particles easily gather around the hydrophilically-processed particles (slipping agent). Herein, the reactive silica particles in a mixture with the matrix resin aggregate with the slipping agent particles. Further, since the dispersant present around the slipping agent is hydrophobic, the slipping agent blends with the reactive silica (A) and the hydrophobic binder component present in the layer in a large amount. Thus, the reactive silica, slipping agent and matrix resin aggregate, and at the same time disperse in the vicinity of the surface of the hard coat layer without gelating in the layer. It is considered that as the result of these reactions together, the three-components-aggregated secondary particles, which can effectively exhibit the anti-blocking property, are formed in the present invention.

The formation of the secondary particle (C) in the curable resin composition for a HC layer can be confirmed by, for example, measuring the particle diameter distribution of particles in the curable resin composition for a HC layer (including Ink 1 and Ink 2 hereinafter described) by dynamic light scattering by means of FPAR-1000 (product name; Otsuka Electronics Co., Ltd.). That is, since the particles contained in the curable resin composition for a HC layer are the reactive silica particle (A) having an average primary particle diameter of 10 to 100 nm and the slipping agent (B) having an average primary particle diameter of 100 to 300 nm, formation of the secondary particle (C) can be confirmed by observation of particles having an average particle diameter greater than 300 nm in a graph of the particle diameter and the scattering intensity distribution obtained by the dynamic light scattering.

The secondary particle (C) is preferably an aggregate containing the reactive silica particles (A), the slipping agent (B) particles and the multifunctional monomer (D). That is, since the secondary particle (C) is an aggregate of particles in which the binder resin is present between particles, the aggregate has flexibility. By the small protrusion shapes formed by the aggregates, the surface of the HC layer smooth compared to the primary particle of the slipping agent (B) having the same particle diameter as the secondary particle (C), thus, the surface less likely be damaged due to the protrusions, and the hardness is kept excellent. Also, since the shapes are smooth, the small protrusion shapes are less likely to cause haze, thus, increase in haze of the HC layer can be suppressed, and the total light transmittance of the HC layer can be increased. If particles only consisting of inorganic material having a particle diameter greater than 100 nm are contained, haze is likely to be caused. The present invention has an advantage that haze is less likely to be caused since the secondary particle is an aggregate containing the resin.

### (Multifunctional Monomer (D))

The multifunctional monomer is a component having two or more reactive functional groups and performs a polymerization or crosslinking reaction of the reactive functional group of the multifunctional monomer with the photocurable group of the reactive silica particle (A) upon curing the curable resin composition for the HC layer to form a net-like structure being the matrix of the HC layer.

The reactive functional group of the multifunctional monomer (D) may be any group capable of reacting with the photocurable group of the reactive silica particle (A), for example, a polymerizable unsaturated group is preferable, and an ionizing radiation-curable unsaturated group is more preferable. Specific examples include ethylenically unsaturated bonds such as a (meth)acryloyl group, a (meth)acryloyloxy group, a vinyl group and an allyl group, and epoxy groups. The reactive functional group is preferably an acryloyl group or acryloyloxy group.

The number of the reactive functional groups in the multifunctional monomer (D) is two or more (two or more reactive functional groups). From the viewpoint of increasing the cross-linking density and increasing the hardness of the HC layer, it is preferable to have 3 to 12 reactive functional groups.

The molecular weight of the multifunctional monomer (D) is 1,000 or less, preferably from 100 to 800. Since the molecular weight of the multifunctional monomer (D) is 1,000 or less, fine convexo-concave shapes can be easily formed upon curing the curable resin composition for the HC layer. When the substrate is made of triacetyl cellulose, the multifunctional monomer also penetrates into inside of the substrate together with the penetrative solvent, which provides the effect of preventing interference fringe.

As the multifunctional monomer (D), any of multifunctional monomers used for forming conventional HC layers may be use as long as it satisfies the above criteria of the reactive functional group and molecular weight d. Examples thereof include ethyl (meth)acrylate, ethylhexyl (meth)acrylate, hexanediol (meth)acrylate, hexanediol (meth)acrylate, tripropylene glycol di(meth)acrylate, diethylene glycol di(meth)acrylate, 1,6-hexanediol di(meth)acrylate, neopentyl glycol di(meth)acrylate, trimethylolpropane tri(meth)acrylate, pentaerythritol tri(meth)acrylate, and dipentaerythritol hexa(meth)acrylate.

Preferable examples of the multifunctional monomer (D) include pentaerythritol triacrylate (PETA) and dipentaerythritol tetraacrylate (DPHA).

The content of the multifunctional monomer (D) is preferably from 30 to 70% by mass with respect to the total mass of the reactive silica particle (A) and the multifunctional monomer (D).

The above multifunctional monomer (D) may be used alone or in combination of two or more kinds.

The radical polymerizable compounds are more preferable compared to the cationic polymerizable compounds to increase hardness as the cross-linking density easily increases though the reason is unknown.

### (Solvent (E))

The solvent is a component to adjust the viscosity of the curable resin composition for the HC layer, and impart the coatability to the curable resin composition for the HC layer.

As the solvent, any of solvents used for conventional curable resin compositions for HC layers may be used. Examples thereof include alcohols such as methanol, ketones such as acetone, methyl ethyl ketone, methyl isobutyl ketone and cyclohexanone, esters such as methyl acetate, ethyl acetate, and butyl acetate, nitrogen-containing compounds such as N,N-dimethylformamide, ethers such as tetrahydrofuran, halogenated hydrocarbons such as trichloroethane and other solvents such as dimethylsulfoxide, and mixtures thereof disclosed in Patent Literature 1.

The solvent is preferably a penetrative solvent penetrative to the TAC substrate, and more preferably at least one selected from the group consisting of methyl acetate, ethyl acetate, butyl acetate, methyl ethyl ketone, methyl isobutyl ketone and cyclohexanone.

This is because by using the penetrative solvent, fine convexo-concave shapes for exhibiting the anti-blocking property on the surface of the HC layer can be easily formed when forming the HC layer on the TAC substrate using the curable resin composition for the HC layer of the present invention.

In the present invention, “penetrative property” means a characteristic which can dissolve, swell or moisten a TAC substrate.

The above solvents may be used alone, or two or more kinds may be used in combination.

The solvent may be added according to the desired coatability, etc. It is preferable that the solid content of the curable resin composition for the HC layer becomes from 20 to 60% by mass, more preferably from 30 to 50% by mass.

### (Other Components)

Besides the essential components, the curable resin composition for the HC layer of the present invention may contain other components, examples of which include other binder components, a polymerization initiator, a leveling agent and an antistatic agent, according to needs.

“Other binder components” means components which form the matrix of the HC layer by curing similarly as the above multifunctional monomer (D).

As other binder components, conventionally known binder components for HC layers may be used. Examples thereof include monofunctional monomers such as styrene and n-vinylpyrrolidone, and compounds having a cationic polymerizable functional group such as bisphenol type epoxy resin compounds, and oligomers and polymers such as aromatic vinyl ethers disclosed in Patent Literature 1.

In the case of using other binder components, it is preferable that the content of other binder components is from 10 to 60% by mass with respect to the total mass of the other binder components and the multifunctional monomer (D), from the viewpoint of obtaining sufficient cross-linking density of the HC layer.

The polymerization initiator is a component which accelerates the curing reaction of the aforementioned multifunctional monomer (D) and other binder components.

As the polymerization initiator, any of polymerization initiators used for conventional curable resin composition for HC layers may be used. Examples thereof include acetophenones, benzophenones, benzoins, thioxanthones, propiophenones, benzyls, acylphosphine oxides, Michler-benzoyl benzoate, α-amyloxim ester, tetramethylthiuram monosulfide, benzoin methyl ether, and 1-hydroxy-cyclohexyl-phenyl-ketone disclosed in Patent Literature 1.

1-hydroxy-cyclohexyl-phenyl-ketone is available, for example, as Irgacure 184 (product name; manufactured by: Ciba Specialty Chemicals, Inc.). α-Aminoalkylphenones are available, for example, as Irgacure 907 and 369 (product names).

In the case of multifunctional monomers and binders having a cationic polymerizable functional group, examples of the photopolymerization initiator which may be used include aromatic diazonium salts, aromatic sulfonium salts, aromatic iodonium salts, metallocene compounds, and benzoin sulfonate.

The above polymerization initiator may be used alone or two or more kinds may be used in combination.

In the case of using the polymerization initiator, the content thereof may be from 0.1 to 10 parts by mass with respect to 100 parts by mass of the total solid content of the curable resin composition for the HC layer.

The leveling agent is a component which imparts coating stability, slipping ability, anti-fouling properties and abrasion resistance to the surface of the coating layer upon coating or drying the curable resin composition for the HC layer.

As the leveling agent, any of leveling agents conventionally used for HC layers may be used, and fluorinated or silicone leveling agents are preferable. Specific examples of the leveling agent include MEGAFACE series manufactured by DIC Corporation, TSF series manufactured by Momentive Performance Materials Inc. and FTERGENT series manufactured by Neos Company Limited disclosed in JP-A No. 2010-122325.

In the case of using the leveling agent, the content thereof may be from 0.01 to 5 parts by mass with respect to 100 parts by mass of the total solid content of the curable resin composition for the HC layer.

The antistatic agent is a component for imparting anti-static properties to HC layers.

As the antistatic agent, any of antistatic agents conventionally used for anti-static layers or HC layers may be used. Examples thereof include cationic compounds such as quaternary ammonium salts, anionic compounds such as sulfonates and sulfates, zwitterionic compounds such as amino acids and amino sulfuric esters, nonionic compounds such as amino alcohols and polyethyleneglycols, organometallic compounds such as alkoxide of tin and titanium and metal chelate compounds such as acetylacetonato salts thereof, and conductive particles such as metal oxides disclosed in Patent Literature 1.

In the case of using the antistatic agent, the content thereof may be from 1 to 30 parts by mass with respect to 100 parts by mass of binder components including the multifunctional monomer (D).

### (Preparation of Curable Resin Composition for Hard Coat Layer)

The curable resin composition for the hard coat layer of the present invention is prepared by mixing and dispersing the above essential components according to the method comprising the following Steps (1) to (3):

(1) mixing a composition comprising at least the reactive silica (A), the multifunctional monomer (D) and the solvent (E) to prepare Ink 1,

(2) mixing a composition comprising at least the slipping agent (B) and the solvent (E) to prepare Ink 2, and

(3) forming the secondary particles (C) by gradually mixing said Ink 2 into said Ink 1 while stirring said Ink 1 to prepare the curable resin composition for the hard coat layer.

Herein, in order to form the secondary particles (C), after adding all of Ink 1 and Ink 2, the mixture is well dispersed. In addition, the mixture is mixed for 30 minutes to 1 hour by means of a general dispersing method such as a paint shaker or a beads mill to surely form the secondary particles.

It is preferable that the curable resin composition for the hard coat layer is applied on the substrate within 24 hours after completing preparation of the curable resin composition. Inks 1 and 2 are able to be stored respectively for a long time once they are prepared so that a required amount of Ink 1 and a required amount of Ink 2 can be mixed when needed. To the contrary, as for the curable resin composition for the hard coat layer obtained by mixing Inks 1 and 2, once it is prepared, the secondary particles (C) being essential to the present invention are formed and the average secondary particle diameter of the secondary particles (C) is kept within the preferable range within 24 hours after the preparation, but aggregation proceeds over 24 hours from the preparation so that the average secondary particle diameter of the secondary particles (C) becomes excessively large. Thereby, the secondary particles may sediment in the curable resin composition for the hard coat layer, and the composition of the curable resin composition for the hard coat layer may change. If a HC layer is formed using such a curable resin composition for the hard coat layer stored over 24 hours from the preparation, it may cause not only increase in haze and decrease in transmittance but also decrease in hardness of the hard coat layer, and further precipitation of massive particles upon production. Therefore, it is preferable to use all the curable resin composition for the hard coat layer of the present invention within 24 hours after completing the preparation of the curable resin composition, or to use the curable resin composition in a facility capable of constant supply in fresh state.

A paint shaker, a beads mill, etc. may be used for mixing and dispersing.

### (Method for Producing Hard Coat Film)

The method for producing the hard coat film of the present invention comprises the steps of:

(i) applying the curable resin composition for the hard coat layer on a triacetyl cellulose substrate to form a coating layer, and

(ii) curing the coating layer by light irradiation to form the hard coat layer.

Since in the curable resin composition for the HC layer, the slipping agent (B) is contained at the above specified ratio and the secondary particles (C) having an average secondary particle diameter of 500 nm to 2,000 nm including the slipping agent (B) particles are contained, the fine small protrusion shapes exhibiting the anti-blocking property are easily formed on the surface of the HC layer.

The coating method of the curable resin composition for the HC layer in Step (i) may not be particularly limited as long as it can uniformly apply the curable resin composition for the HC layer on the surface of a TAC substrate, and any of conventionally-known methods for coating a curable resin composition for a HC layer can be used. Examples thereof include a slide coating method, a bar coating method and a roll coater method disclosed in Patent Literature 1.

The coating amount of the composition for the HC layer on the TAC substrate differs from performances required for hard coat films to be obtained. The coating amount after drying is preferably from 1 to 30 g/m², more preferably from 5 to 25 g/m².

In the method of producing the HC film of the present invention, it is preferable that after the curable resin composition for the HC layer is applied and a coating layer is formed, drying is performed before curing by light irradiation, etc.

Drying may be performed, for example, by drying under reduced pressure or heat, or a combination thereof. For example, the drying step is generally performed at room temperature to 80°, preferably at 40 to 60° C., approximately for 20 seconds to 3 minutes, preferably for 30 seconds to 1 minute, in the case of using a ketone solvent as the solvent.

Next, in Step (ii), the coating layer is subjected to light irradiation or light irradiation and heating according to the photocurable group and reactive functional group contained in the curable resin composition for the HC layer to cure the coating layer. The photocurable group of the reactive silica particle (A) crosslinks with the reactive functional group of the multifunctional monomer (D) in the curable resin composition for the HC layer. The multifunctional monomer (D) becomes a matrix. Thus, the hard coat layer consisting of a cured product of the curable resin composition for the HC layer is formed.

For the light irradiation, in many cases, ultraviolet rays, visible light, electron beam, ionizing radiation or the like is used. In the case of ultraviolet curing, for example, ultraviolet rays emitted from a light source such as an ultra-high-pressure mercury lamp, a high-pressure mercury lamp, a low-pressure mercury lamp, a carbon arc lamp, a xenon arc lamp or a metal halide lamp can be used. The irradiance level of energy beam source is from 50 to 5,000 mJ/cm² as the integral exposure amount of light at the ultraviolet wavelength of 365 nm.

In the case of heating in addition to light irradiation, the treatment is performed normally at a temperature in the range from 40 to 120° C. The reaction may be performed by leaving the coating layer under room temperature (25° C.) for 24 hours or more.

In the method for producing the HC film of the present invention, the solvent (E) in the curable resin composition for the HC layer is preferably a penetrative solvent, since the fine small protrusion shapes can be easily formed on the surface of the HC layer and the anti-blocking property can be increased.

The penetrative solvent is preferably at least one kind selected from the group consisting of methyl acetate, ethyl acetate, butyl acetate, methyl ethyl ketone, methyl isobutyl ketone and cyclohexanone.

FIG. 1 is a view schematically showing an example of a flow of the method for producing the hard coat film of the present invention.

After the coating layer is formed by applying the curable resin composition for the HC layer on the triacetyl cellulose substrate 10, the coating layer is subjected to light irradiation to cure. Thus, the hard coat layer 20 is formed. At this time, fine small protrusion shapes are formed on the surface of the hard coat layer 20.

In schematic views in FIG. 1, etc., the silica particles and the slipping agent in the HC layer are not shown to simplify the explanation.

In the method of producing the HC film of the present invention, there may be steps of providing other layers such as a low refractive index layer, an anti-fouling layer, etc. hereinafter described on the surface of the HO layer on the side opposite to the TAC substrate. These other layers may be formed by preparing and applying a composition followed by curing by light irradiation or heating, similarly as the method of forming the HC layer.

### (Hard Coat Film)

The HC film of the present invention can be obtained by the aforementioned production method.

The HC film obtained by the production method using the curable resin composition for the HC layer has fine small protrusion shapes on the surface of the HC layer, is excellent in anti-blocking property, and has low haze and high total light transmittance.

The haze of the HC film of the present invention is preferably 1.2 or less, more preferably 1.0 or less, even more preferably 0.5% or less.

The total light transmittance of the HC film of the present invention is preferably 90% or more, more preferably 92.0% or more.

The fine small protrusion shapes on the surface of the HC layer preferably have convex moieties on the surface of the HC layer similarly as disclosed in Patent Literature 2. The height of the convex moieties is more than 3 nm and 50 nm or less and the interval between convex moieties is preferably from 100 to 6,000 nm, more preferably from 100 to 5,000 nm, from the viewpoint of excellent anti-blocking property. It is important that such fine convex moieties are appropriately present at an interval within 6,000 nm.

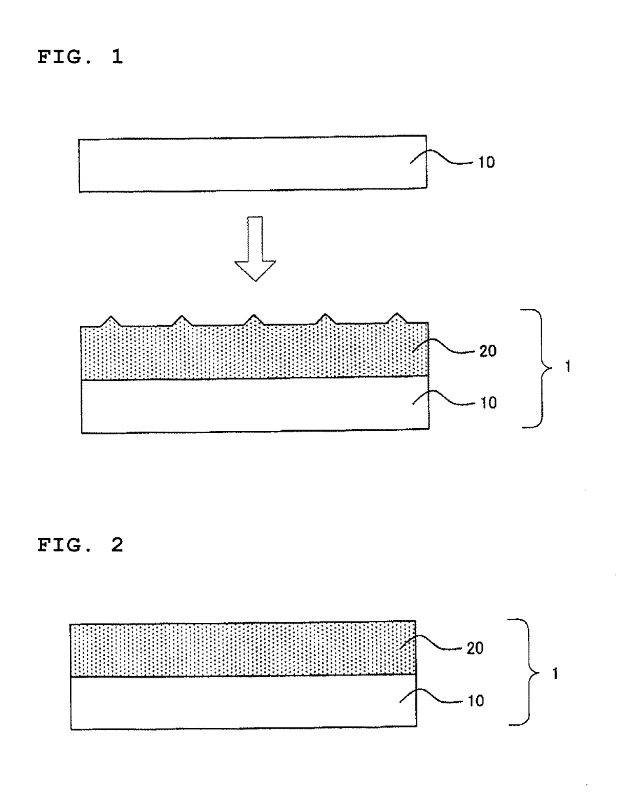

FIG. 2 is a view schematically showing an example of a layer structure of the hard coat film of the present invention.

The hard coat layer 20 is provided on one surface of the triacetyl cellulose substrate 10.

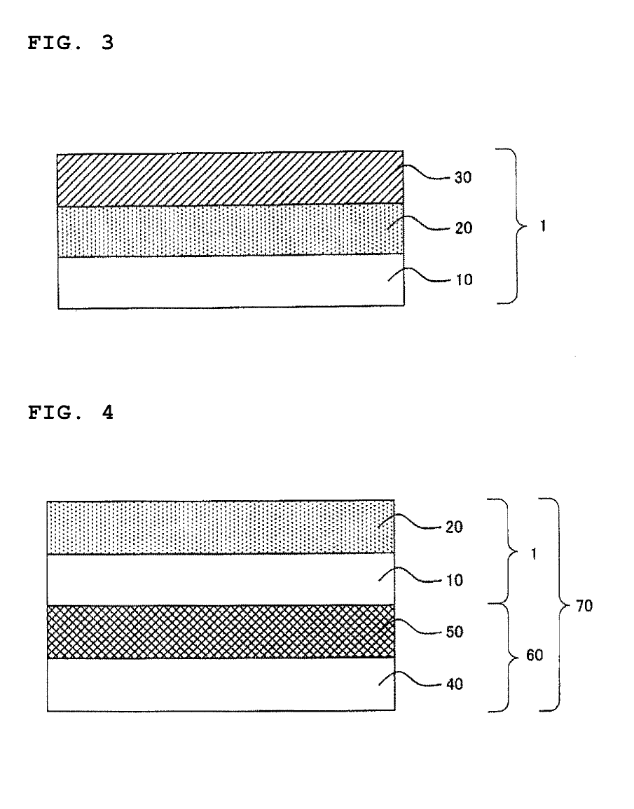

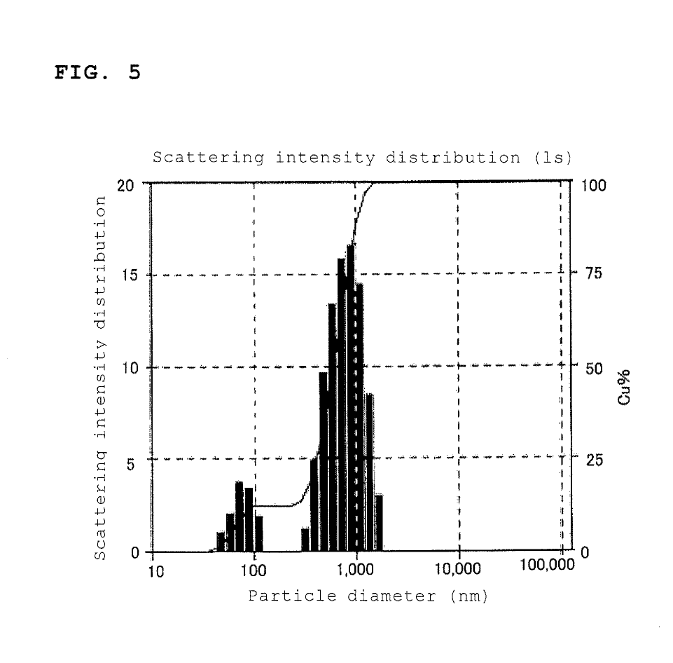

FIG. 3 is a view schematically showing another example of the layer structure of the hard coat film of the present invention.

On one surface of the triacetyl cellulose substrate 10, the hard coat layer 20 and the low refractive index layer 30 are provided in this order from the triacetyl cellulose substrate side.

In the HC layers of FIGS. 2 and 3 and FIG. 4 hereinafter described, fine concave-convex shapes on the surface of the HC layer are omitted and schematically shown to simplify the explanation.

Hereinafter, the TAC substrate and HC layer being essential components of the HC film of the present invention, and other layers such as a low refractive index layer, a high refractive index layer, an intermediate refractive index layer and an anti-fouling layer, which may be provided according to needs, will be explained.

### (Triacetyl Cellulose Substrate)

The triacetyl cellulose substrate used in the present invention is a triacetyl cellulose film having high optical transparency. The triacetyl cellulose substrate of the present invention is not particularly limited as long as it has physical properties that are required for optically-transparent substrates of hard coat films. The TAC substrate used for conventionally-known hard coat films or optical films may be accordingly selected and used.

The average light transmittance of the TAC substrate in the visible light region from 380 to 780 nm is preferably 80% or more, more preferably 90% or more. Light transmittance is measured by means of an ultraviolet-visible spectrophotometer (for example; product name: UV-3100PC; manufactured by Shimadzu Corporation) and values obtained at room temperature in the air are used.

The surface treatment such as saponification treatment or providing a primer layer may be performed on the TAC substrate. Additives such as an anti-static agent, etc. may be added.

The thickness of the TAC substrate is not particularly limited, and is generally from 20 to 200 μm, preferably from 40 to 70 μm.

If the penetrative solvent is used as the solvent (E) in the HC film of the present invention as described in the production method, the multifunctional monomer (D) penetrates into the TAC substrate inward from the interface between the TAC substrate and the HC layer to the vicinity of the interface, and is cured. Thereby, the adhesion between the TAC substrate and the HC layer improves.

Herein, the “vicinity of the interface” means a region of the TAC substrate in the thickness direction from the interface on the HC layer side to 10 μm in the inward direction of the TAC substrate.

### (Hard Coat Layer)

The HC layer of the present invention is formed of a cured product of the composition for the HC layer, and has fine small protrusion shapes on the surface opposite to the TAC substrate side.

The thickness of the HC layer may be appropriately adjusted according to required performance, for example, the thickness may be from 1 to 20 μm. The thickness of the HC layer is preferably from 5 to 15 μm.

### (Other Layers)

In the hard coat film of the present invention, one or more other layers such as a low refractive index layer, a high index layer, an intermediate refractive index layer, an anti-fouling layer, etc. may be provided on the surface of the HC layer on the side opposite to the TAC substrate within the scope of the present invention.

Examples of layer structures of the HC film having the above other layers include the following (1) to (5):

(1) low refractive index layer/EC layer/TAC substrate;

(2) anti-fouling layer/low refractive index layer/HC layer/TAC substrate;

(3) low refractive index layer/high refractive index layer/HC layer/TAC substrate;

(4) low refractive index layer/high refractive index layer/intermediate refractive index layer/HC layer/TAC substrate; and

(5) anti-fouling layer/low refractive index layer/high refractive index layer/intermediate refractive index layer/HC layer/TAC substrate.

Hereinafter, said other layers will be explained.

### (Low Refractive Index Layer)

The low refractive index layer is a layer adjusting the reflectance ratio of the HC film, and functioning to increase the visibility of the surface of the HC film.

The low refractive index layer is formed of a cured product of a composition comprising a component having low refractive index such as silica or magnesium fluoride and a binder component, or a composition comprising a fluorine-containing resin such as vinylidene fluoride copolymer. Conventionally known low refractive index layers may be used as the low refractive index layer.

The composition for forming the low refractive index layer may contain a hollow particle(s) for decreasing the refractive index of the low refractive index layer.

The hollow particle means a particle having an outer shell layer and the inside surrounded by the outer shell layer is a porous structure or hollow. Air (refractive index: 1) is contained in such porous structure or hollow. By adding the hollow particle having a refractive index of 1.20 to 1.45 in the low refractive index layer, the refractive index of the low refractive index layer can be decreased.

The average particle diameter of hollow particle is preferably from 1 to 100 nm.

As the hollow particle, any of conventionally known hollow particles used for low refractive index layers may be used. The examples include particles having voids disclosed in JP-A No. 2008-165040.

### (High Refractive Index Layer and Intermediate Refractive Index Layer)

The high refractive index layer and intermediate refractive index layer are layers which can be provided to adjust the reflectance of the HC film.

In the case of providing the high refractive index layer (not shown), generally, the high refractive index layer is provided adjacent to the low refractive index layer on the TAC substrate side. In the case of providing the intermediate refractive index layer (not shown), generally, the intermediate refractive index layer, the high refractive index layer and the low refractive index layer are provided in this order from the TAC substrate side.

The high refractive index layer and the intermediate refractive index layer are formed of a cured product of compositions mainly containing a binder component and particles for adjusting the refractive index. As the binder component, resins such as the multifunctional monomer (D) described for the composition for the HC layer can be used.

As the particles for adjusting refractive index, for example, there may be fine particles having a particle diameter of 100 nm or less. As the particle, there may be one or more kinds selected from the group consisting of zinc oxide (refractive index: 1.90), titania (refractive index: 2.3 to 2.7), ceria (refractive index: 1.95), tin doped indium oxide (refractive index: 1.95), antimony doped tin oxide (refractive index: 1.80), yttria (refractive index: 1.87), and zirconia (refractive index: 2.0).

Specifically, the high refractive index layer preferably has a refractive index of 1.50 to 2.80.

The intermediate refractive index layer has lower refractive index than the high refractive index layer and preferably has a refractive index of 1.50 to 2.00.

### (Anti-Fouling Layer)

In the preferable embodiment of the present invention, the anti-fouling layer can be provided on the outermost surface of the HC film on the side opposite to the TAC substrate for the purpose of preventing the outermost surface of the HC film from contamination. The anti-fouling layer can impart excellent anti-fouling properties and abrasion resistance to the HC film. The anti-fouling layer is formed of a cured product of a composition for the anti-fouling layer comprising an anti-fouling agent and a binder component.

A binder component for the composition for the anti-fouling layer may be any of conventionally-known binders, for example, the multifunctional monomer (D) mentioned for the composition for a HC layer may be used.

As the antifouling agent in the composition for the anti-fouling layer, one or more kinds accordingly selected from the group consisting of anti-fouling agents such as conventionally known leveling agents can be used. The anti-fouling agent listed for the composition for the HC layer may be used.

The content of the antifouling agent may be from 0.01 to 0.5 parts by mass with respect to 100 parts by mass of the total solid content of the composition for the anti-fouling layer.

The compositions for forming the aforementioned other layers may be prepared similarly as the composition for the HC layer.

### (Polarizing Plate)

The polarizing plate of the present invention comprises the hard coat film, and a polarizer provided on the triacetyl cellulose substrate side of the hard coat film

FIG. 4 is a view schematically showing an example of a layer structure of the polarizing plate of the present invention. The polarizing plate 70 shown in FIG. 4 has the HC film 1 and the polarizer 60 comprising a protecting film 40 and a polarizing layer 50 being laminated, and the polarizer 60 is provided on the triacetyl cellulose substrate 10 side of the HC film 1.

“A polarizer is provided on the triacetyl cellulose substrate side of the hard coat film” includes not only the case wherein the HC film and the polarizer are separately formed, but also the case wherein a member constituting the HC film also constitutes the polarizer.

When using the polarizing plate of the present invention for a display panel, a display is usually disposed on the polarizer side.

As the HC film, the aforementioned HC film can be used, thus, the explanation is omitted herein. Hereinafter, other components of the polarizing plate of the present invention will be explained.

### (Polarizer)

The polarizer 60 used for the present invention may not be particularly limited if it has predetermined polarization properties, and polarizers generally used for liquid crystal displays may be used.

The polarizer 60 may not be particularly limited if it is in a form that predetermined polarization properties can be retained for long periods, for example, it may be constituted with a polarizing layer 50 alone, or may be a laminate of the protecting film 40 and the polarizing layer 50. When the protecting film 40 and the polarizing layer 50 are laminated, the protecting film 40 may be formed only on one side of the polarizing layer 50, or protecting films 40 may be formed on both sides of the polarizing layer 50.

As the polarizing layer, generally, one obtained by impregnating a film made of polyvinyl alcohol with iodine, and performing uniaxial orientation with the film to form a complex of the polyvinyl alcohol and the iodine, may be used.

The protecting film is not particularly limited if it can protect the polarizing layer, and has a desired optical transparency.

As for the optical transparency of the protecting film, the transmittance in the visible light region is preferably 80% or more, more preferably 90% or more.

The transmittance of the protecting film can be measured as defined in JIS K7361-1 (Plastics—Determination of the total luminous transmittance of transparent materials).

Examples of the resin constituting the protecting film include cellulose derivatives, cycloolefin-based resins, polymethyl methacrylate, polyvinyl alcohols, polyimides, polyarylates, and polyethylene terephthalate. Among the above, it is preferable to use a cellulose derivative or a cycloolefin-based resin.

The protecting film may be a single layer or a laminate consisting of plural layers. In the case that the protecting film is a laminate consisting of plural layers, plural layers of the same composition may be layered or plural layers of different compositions may be layered.

The thickness of the protecting film may not be particularly limited as long as the flexibility of the polarizing plate of the present invention is within a desired range and the dimensional variation of the polarizer is within a predetermined range when the protecting film is adhered on the polarizing layer, and is preferably from 5 to 200 μm, more preferably from 15 to 150 μm, even more preferably from 30 to 100 μm, and most preferably 65 μm or less. If the above thickness is less than 5 μm, the dimensional variation of the polarizing plate of the present invention may become high. If the above thickness is more than 200 μm, for example, the amount of process waste may increase or a cutting blade is quickly worn away upon a cutting process of the polarizing plate of the present invention.

The protecting film may have a phase difference property. By using a protecting film having the phase difference property, there is an advantage that the polarizing plate of the present invention can have the viewing angle compensation function of a display panel.

The embodiment of the protecting film having the phase difference property may not be particularly limited if it is an embodiment capable of exhibiting a desired phase difference property. Examples of such an embodiment include an embodiment wherein the protecting film consists of a single layer and has the phase difference property by containing an optical property exhibiting agent for exhibiting the phase difference property, and an embodiment wherein a phase difference layer containing a compound having refractive index anisotropy is layered on the protecting film formed of the aforementioned resin, thereby having the phase difference property. Any of the embodiments can be suitably used in the present invention.

### (Display Panel)

The display panel of the present invention comprises the HC film, and a display provided on the triacetyl cellulose substrate side of the HC film.

Examples of the display include LCD, PDP, ELD (organic EL, inorganic EL), CRT touch panels, electronic papers, tablet PCs, etc.

A representative example of the display, LCD, comprises a transmissive display and a light source device irradiating from the back side of the transmissive display. In the case that the above described display is LCD, the HC film of the present invention or the polarizing plate provided with the HC film is arranged on the surface of the transmissive display.

Another example of the display, PDP, comprises a surface glass substrate and a back-surface glass substrate arranged to face the surface glass substrate and discharge gas is included therebetween. In the case that the display is PDP, the HC film is provided on the surface of the surface glass substrate or its front face plate (glass substrate or film substrate).

The display may be an ELD device, wherein illuminant such as zinc sulfide, diamines substance, etc. emitting light when voltage is applied is deposited on a glass substrate, and the voltage applied on the substrate is controlled to display, or a display such as CRT, which transforms an electric signal to light and generates images visible to human being. In these cases, the aforementioned HC film is provided on the outermost surface of the ELD device or CRT or on the surface of the front face plate thereof.

### EXAMPLES

Hereinafter, with reference to Examples, the present invention will be explained in more detail, but the present invention may not be limited thereby.

### Example 1

### (1) Preparation of Curable Resin Composition for Hard Coat Layer

Firstly, the following components were mixed according to Step (1) to prepare Ink 1, and the following components were mixed according to Step (2) to prepare Ink 2.

Next, in Step (3), while stirring Ink 1 with a stirring rod, Ink 2 was added gradually. When addition of Ink 2 was completed, the mixture was further mixed and dispersed by means of a paint shaker for 30 minutes to form secondary particles (C). Finally, a curable resin composition for a hard coat layer, the solid content of which was adjusted to 45% by mass, was prepared. The secondary particle diameter of the present invention was measured with the ink after this Step (3) as it is.

### Step (1)

Reactive silica particle (A) (product name: MIBK-SDL; manufactured by: Nissan Chemical Industries, Ltd.; average primary particle diameter: 44 nm; solid content: 30% liquid (MIBK dispersion); photocurable group: methacryloyl group): 42.3 parts by mass (solid content-equivalent value).

Multifunctional monomer (D) (PETA; reactive functional group: acryloyloxy group, trifunctional): 51.7 parts by mass.

Leveling agent (product name: MCF350; manufactured by: DIC CORPORATION): 0.3 parts by mass.

1-hydroxy-cyclohexyl-phenyl-ketone (product name: Irgacure 184; manufactured by: Ciba Specialty Chemicals, Inc.): 3.8 parts by mass.

Solvent (E) (methyl ethyl ketone).

### Step (2)

Slipping agent (B) (product name: SIRMEK-E03; manufactured by: CIK NANOTECH CO. LTD.; average primary particle diameter: 147 nm; material; SiO₂): 1.9 parts by mass.

Solvent (E) (methyl ethyl ketone).

### (2) Production of Hard Coat Film

As a TAC substrate, a cellulose triacetate film (product name: KC4UYW; manufactured by: Konica Minolta Opto Products Co., Ltd.) having a thickness of 40 μm was used. The curable resin composition for the hard coat layer prepared in Step (1) was applied on the TAC substrate within one hour from completing the preparation of the composition by a coating method (Mayor bar coating #14), and dried at 70° C. for one minute. After performing a nitrogen purge, irradiation of ultraviolet ray of 240 mJ/cm² was performed. Thereby, a hard coat film of Example 1 having a thickness (when dried) of 10 μm was produced.

### Example 2

Except that the content of the slipping agent (B) with respect to the total mass of the reactive silica particles (A) and the multifunctional monomer (D) was changed to 0.2% by mass, a composition for a HC layer was prepared similarly as Example 1, and applied within one hour from preparation. Thereby, a HC film was produced.

### Example 3

Except that the content of the slipping agent (B) with respect to the total mass of the reactive silica particles (A) and the multifunctional monomer (D) was changed to 8.0% by mass, a composition for a HC layer was prepared similarly as Example 1, and applied within one hour from preparation. Thereby, a HC film was produced.

### Example 4

Except that the slipping agent (B) was changed to a slipping agent (B) having an average primary particle diameter of 100 nm (product name: IPA-ST-ZL; manufactured by: Nissan Chemical Industries, Ltd.), a composition for a HC layer was prepared similarly as Example 1, and applied within one hour from preparation. Thereby, a HC film was produced.

### Example 5

Except that the slipping agent (B) was changed to a slipping agent (B) (product name: MG-164; manufactured by: NIPPON PAINT Co., Ltd.; average primary particle diameter: 300 nm; material: styrene acrylic compound), a composition for a HC layer was prepared similarly as Example 1, and applied within one hour from preparation. Thereby, a HC film was produced.

### Example 6

Except that the slipping agent (B) was changed to a slipping agent (B) (product name: TDNP-026; manufactured by: Takemoto Oil & Fat Co., Ltd.; average primary particle diameter: 240 nm; material: silicone), a composition for a HC layer was prepared similarly as Example 1, and applied within one hour from preparation. Thereby, a HC film was produced.

### Example 7

Except that the reactive silica particle (A) was changed to a reactive silica particle (A) having an average primary particle diameter of 10 nm (product name: ELCOM DP-1116SIV; manufactured by: JGC Catalysts and Chemicals Ltd.), a composition for a HC layer was prepared similarly as Example 1, and applied within one hour from preparation. Thereby, a HC film was produced.

### Example 8

Except that the reactive silica particle (A) was changed to a reactive silica particle (A) having an average primary particle diameter of 100 nm (product name: ELCOM DP-1119SIV; manufactured by: JGC Catalysts and Chemicals Ltd.), a composition for a HC layer was prepared similarly as Example 1, and applied within one hour from preparation. Thereby, a HC film was produced.

### Example 9

Except that the reactive silica particle (A) was changed to a reactive silica particle (A) having an average primary particle diameter of 100 nm (product name: ELCOM DP-1119SIV; manufactured by: JGC Catalysts and Chemicals Ltd.) and the content of the slipping agent (B) with respect to the total mass of the reactive silica particle (A) and the multifunctional monomer (D) was changed to 3.0% by mass, a composition for a HC layer was prepared similarly as Example 1, and applied within one hour from preparation. Thereby, a HC film was produced.

### Comparative Example 1

Except that the content of the slipping agent (B) with respect to the total mass of the reactive silica particle (A) and the multifunctional monomer (D) was changed to 0.1% by mass, a composition for a HC layer was prepared similarly as Example 1, and applied within one hour from preparation. Thereby, a HC film was produced.

### Comparative Example 2

Except that the content of the slipping agent (B) with respect to the total mass of the reactive silica particle (A) and the multifunctional monomer (D) was changed to 10.0% by mass, a composition for a HC layer was prepared similarly as Example 1, and applied within one hour from preparation. Thereby, a HC film was produced.

### Comparative Example 3

Except that the slipping agent (B) was changed to a slipping agent having an average primary particle diameter of 15 nm (product name: IPA-ST; manufactured by: Nissan Chemical Industries, Ltd.), a composition for a HC layer was prepared similarly as Example 1, and applied within one hour from preparation. Thereby, a HC film was produced.

### Comparative Example 4

Except that the slipping agent (B) was changed to a slipping agent having an average primary particle diameter of 50 nm (product name: IPA-ST; manufactured by: Nissan Chemical Industries, Ltd.), a composition for a HC layer was prepared similarly as Example 1, and applied within one hour from preparation. Thereby, a HC film was produced.

### Comparative Example 5

Except that the slipping agent (B) was changed to a slipping agent (product name: TDNP-027; manufactured by: Takemoto Oil & Fat Co., Ltd.; average primary particle diameter: 360 nm; material: silicone), a composition for a HC layer was prepared similarly as Example 1, and applied within one hour from preparation. Thereby, a HC film was produced.

### Comparative Example 6

Except that the slipping agent (B) was changed to a slipping agent (product name: MX-150; manufactured by: Soken Chemical & Engineering Co., Ltd.; average primary particle diameter: 1,500 nm; material: acrylic compound), a composition for a HC layer was prepared similarly as Example 1, and applied within one hour from preparation. Thereby, a HC film was produced.

### Comparative Example 7

Except that the secondary particle (C) was changed to a secondary particle having an average secondary particle diameter of 285 nm, a composition for a HC layer was prepared similarly as Example 1, and applied within one hour from preparation. Thereby, a HC film was produced.

### Comparative Example 8

Except that the reactive silica particle (A) was changed to a reactive silica particle having an average primary particle diameter of 120 nm (product name: ELCOM DP-1120SIV; manufactured by: JGC Catalysts and Chemicals Ltd.), a composition for a HC layer was prepared similarly as Example 1, and applied within one hour from preparation. Thereby, a HC film was produced.

### Comparative Example 9

Except that the multifunctional monomer (D) was changed to a monomer having one functional group (acryloyloxy group) (product name: VISCOAT #158; manufactured by: Osaka Organic Chemistry Industry Ltd.), a composition for a HC layer was prepared similarly as Example 1, and applied within one hour from preparation. Thereby, a HC film was produced.

### Comparative Example 10

Except that the multifunctional monomer (D) was changed to a monomer having six functional groups (acryloyloxy groups) and a molecular weight of 1,500 (product name: UX-5000; manufactured by: NIPPON KAYAKU CO., LTD.), a composition for a HC layer was prepared similarly as Example 1, and applied within one hour from preparation. Thereby, a HC film was produced.

### Comparative Example 11

Except that the TAC substrate was changed to a PET substrate (product name: A4300; manufactured by: Toyobo Co., Ltd.; thickness: 125 μm), a HC film was produced similarly as Example 1.

### Comparative Example 12

Except that the reactive silica (A) and the slipping agent (B) were not added, a HC film was produced similarly as Example 1.

### Comparative Example 13

Except that the content of the reactive silica (A) was changed to 20% by mass, a HC film was produced similarly as Example 1.

### Comparative Example 14

Except that the content of the reactive silica (A) was changed to 80% by mass, a HC film was produced similarly as Example 1.

### Comparative Example 15

Except that the content of the slipping agent (B) was changed to 0.1% by mass, a HC film was produced similarly as Example 1.

### Comparative Example 16

Except that the content of the slipping agent (B) was changed to 9.0% by mass, a HC film was produced similarly as Example 1.

Table 1 shows the composition of the composition for the HC layer, the average secondary particle diameter of the secondary particle (C) and the substrate of each of Examples 1 to 9 and Comparative examples 1 to 16.

TABLE 1

| | | | | | | | | Secondary | Multifunctional | |
|---|---|---|---|---|---|---|---|---|---|---|
| | | Reactive silica (A) | | | Slipping agent (B) | | | particle (C) | monomer (D) | |
| | | | | Average | | Average | | Average | Number of | |
| | | | | primary | | primary | | secondary | reactive | |
| | | | | particle | | particle | | particle | functional | |
| | | | Content | diameter | | diameter | Content | diameter | groups | Molecular |
| | Substrate | Material | (%) | (nm) | Material | (nm) | (%)* | (nm) | (groups) | weight |
| Example 1 | TAC | SiO₂ | 45 | 44 | SiO₂ | 147 | 2.0 | 1000 | 3 | 298 |
| Example 2 | TAC | SiO₂ | 45 | 44 | SiO₂ | 147 | 0.2 | 500 | 3 | 298 |
| Example 3 | TAC | SiO₂ | 45 | 44 | SiO₂ | 147 | 8.0 | 1000 | 3 | 298 |
| Example 4 | TAC | SiO₂ | 45 | 44 | SiO₂ | 100 | 2.0 | 1000 | 3 | 298 |
| Example 5 | TAC | SiO₂ | 45 | 44 | styrene · acrylic | 300 | 2.0 | 1100 | 3 | 298 |
| | | | | | compound | | | | | |
| Example 6 | TAC | SiO₂ | 45 | 44 | silicone | 240 | 2.0 | 1200 | 3 | 298 |
| Example 7 | TAC | SiO₂ | 45 | 10 | SiO₂ | 147 | 2.0 | 1100 | 3 | 298 |
| Example 8 | TAC | SiO₂ | 45 | 100 | SiO₂ | 147 | 2.0 | 1650 | 3 | 298 |
| Example 9 | TAC | SiO₂ | 45 | 100 | SiO₂ | 147 | 3.0 | 2000 | 3 | 298 |
| Comparative | TAC | SiO₂ | 45 | 44 | SiO₂ | 147 | 0.1 | 110 | 3 | 298 |
| example 1 | | | | | | | | | | |
| Comparative | TAC | SiO₂ | 45 | 44 | SiO₂ | 147 | 10.0 | 534 | 3 | 298 |
| example 2 | | | | | | | | | | |
| Comparative | TAC | SiO₂ | 45 | 44 | SiO₂ | 15 | 2.0 | 70 | 3 | 298 |
| example 3 | | | | | | | | | | |
| Comparative | TAC | SiO₂ | 45 | 44 | SiO₂ | 50 | 2.0 | 90 | 3 | 298 |
| example 4 | | | | | | | | | | |
| Comparative | TAC | SiO₂ | 45 | 44 | silicone | 360 | 2.0 | 1800 | 3 | 298 |
| example 5 | | | | | | | | | | |
| Comparative | TAC | SiO₂ | 45 | 44 | acrylic | 1500 | 2.0 | 2500 | 3 | 298 |
| example 6 | | | | | compound | | | | | |
| Comparative | TAC | SiO₂ | 45 | 44 | SiO₂ | 147 | 2.0 | 285 | 3 | 298 |
| example 7 | | | | | | | | | | |
| Comparative | TAC | SiO₂ | 45 | 120 | SiO₂ | 147 | 2.0 | 3200 | 3 | 298 |
| example 8 | | | | | | | | | | |
| Comparative | TAC | SiO₂ | 45 | 44 | SiO₂ | 147 | 2.0 | 1000 | 1 | 158 |
| example 9 | | | | | | | | | | |
| Comparative | TAC | SiO₂ | 45 | 44 | SiO₂ | 147 | 2.0 | 1000 | 6 | 1500 |
| example 10 | | | | | | | | | | |
| Comparative | PET | SiO₂ | 45 | 44 | SiO₂ | 147 | 2.0 | 1000 | 3 | 298 |
| example 11 | | | | | | | | | | |
| Comparative | TAC | — | 0 | — | 0 | — | — | — | 3 | 298 |
| example 12 | | | | | | | | | | |
| Comparative | TAC | SiO₂ | 20 | 44 | SiO₂ | 147 | 2.0 | 1000 | 3 | 298 |
| example 13 | | | | | | | | | | |
| Comparative | TAC | SiO₂ | 80 | 44 | SiO₂ | 147 | 2.0 | 1000 | 3 | 298 |
| example 14 | | | | | | | | | | |
| Comparative | TAC | SiO₂ | 45 | 44 | SiO₂ | 147 | 0.1 | 500 | 3 | 298 |
| example 15 | | | | | | | | | | |
| Comparative | TAC | SiO₂ | 45 | 44 | SiO₂ | 147 | 9.0 | 1000 | 3 | 298 |
| example 16 | | | | | | | | | | |

*The content of slipping agent (B) is a ratio with respect to the total mass of reactive silica (A) and multifunctional monomer (D).

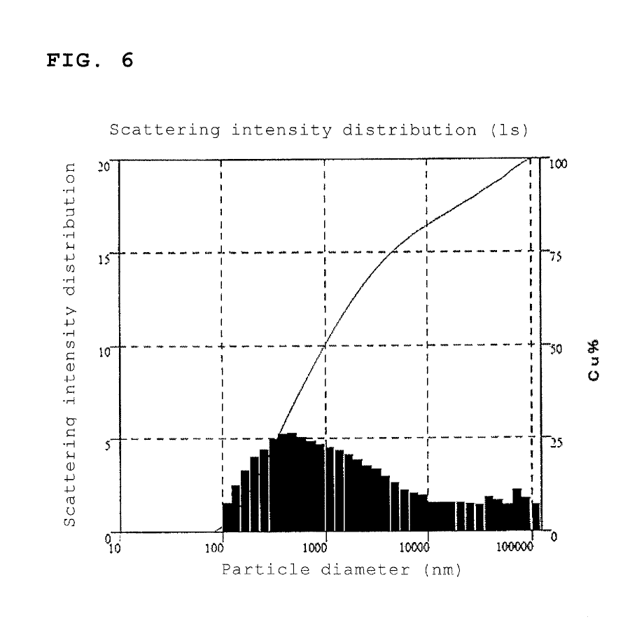

The composition for the HC layer of each of Example 1, Comparative examples 2 and 7 was measured by the dynamic light scattering by means of FPAR-1000 (product name; manufactured by: Otsuka Electronics Co., Ltd.). The relationships between the particle diameter and the scattering intensity distribution thus obtained are shown in the graphs of FIGS. 5 to 7.

It can be understood that the average primary particle diameters of the reactive silica particle (A) and the slipping agent (B) contained in the composition for the HC layer of Example 1 are 44 nm and 147 nm respectively, and the average secondary particle diameter of the secondary particle (C) contained in the composition for the HC layer of Example 1 is 1,000 nm from FIG. 5. In the present invention, since two kinds of particles are contained in the composition, there may be two peaks in the particle size distribution as shown in FIG. 5. In this case, the particle diameter regarded as that of the secondary particle (C) of the present invention is the larger particle diameter, since, for example, the secondary particle diameters of Comparative examples 3 and 4 are less than 100 nm and thus the anti-blocking property was not exhibited. The smaller particle diameter in FIG. 5 is about 100 nm, and it is known that particles having such a level of secondary particle diameter cannot obtain the effect.

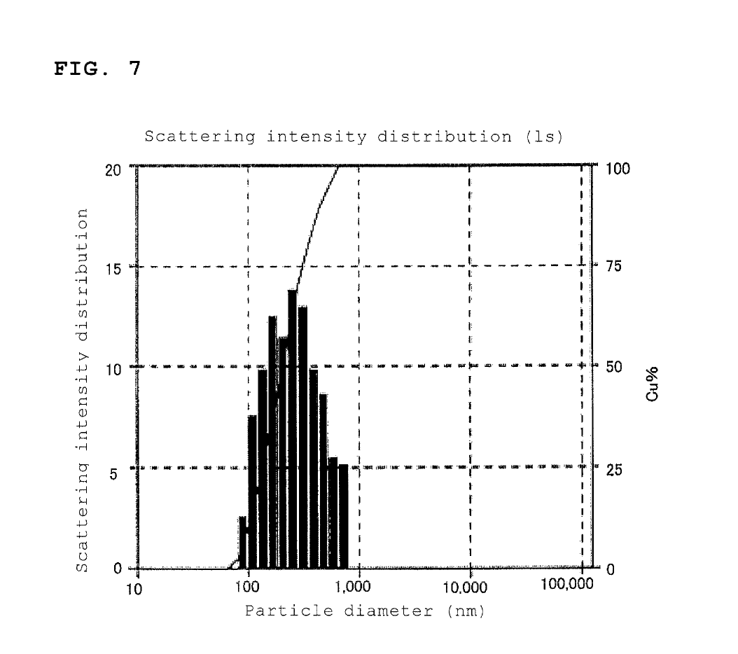

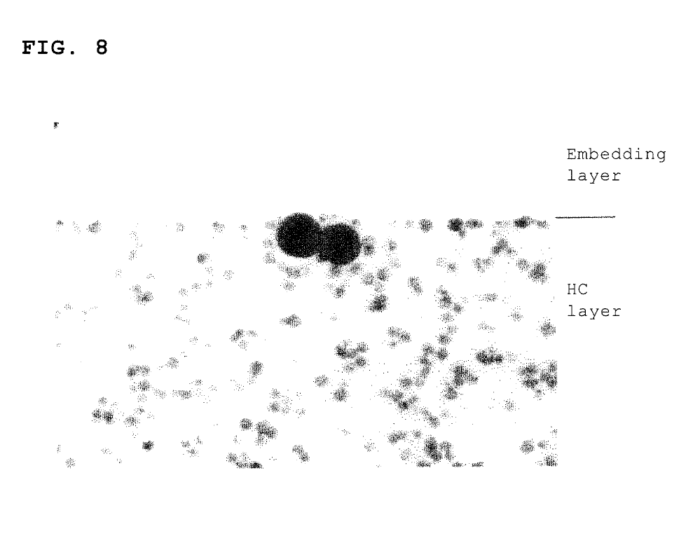

Similarly, the average secondary particle diameters of the secondary particle (C) contained in the compositions for the HC layer of Comparative examples 2 and 7 are 534 nm and 285 nm respectively from FIGS. 6 and 7.

In a TEM photograph (not shown) of the vicinity of the boundary of the HC layer and the TAC substrate in the section of the HO film of Example 1, it was observed that there is a region in which PETA (multifunctional monomer (D)) contained in the composition for the HC layer penetrates into the TAC substrate and is cured within the region between the interface of the TAC substrate on the HC layer side and the thickness of about 100 nm from the interface.

### (Evaluation)

The pencil hardness, haze, and anti-sticking property (anti-blocking property) of the hard coat films obtained in Examples 1 to 9 and Comparative examples 1 to 16 were evaluated as follows. The results are shown in Table 2.

### (1) Pencil Hardness

As for pencil hardness, the pencil hardness test defined in JIS K5600-5-4 (1999) was performed on the hard coat films produced using a test pencil defined in JIS-S-6006 with a load of 4.9 N, after conditioning the humidity of the hard coat films for two hours under the condition of a temperature of 25° C. and a relative humidity of 60%. Therefrom, the highest hardness which caused no damage was determined.

### (2) Haze

The haze of each hard coat film produced was measured by means of a haze meter (product number: HM-150; manufactured by: Murakami Color Research Laboratory) according to the transmission method in JIS-K-7136.

### (3) Total Light Transmittance

The total light transmittance (%) of each hard coat film produced was measured by means of a haze meter (product number: HM-150; manufactured by: Murakami Color Research Laboratory) according to JIS K-7361.

### (4) Anti-Blocking Property

The hard coat layer formed surface and the film surface of the HC film were layered, subjected to the pressure of 3,922.66 kPa, and left for 20 minutes. Thereafter, evaluation was performed.

### (Criterion for Evaluation)

Evaluation ∘: no sticking.

Evaluation x: partial or complete sticking.

TABLE 2

| | Evaluation | | | | | |
|---|---|---|---|---|---|---|
| | | | Total light | | | |
| | Haze | | transmittance | | Anti-blocking | Pencil |
| | (%) | | (%) | | property | hardness |
| Example 1 | 0.4 | ⊚ | 92.1 | ◯ | ◯ | 3H |
| Example 2 | 0.3 | ⊚ | 92.2 | ◯ | ◯ | 3H |
| Example 3 | 1.2 | ◯ | 91.8 | ◯ | ◯ | 2H |
| Example 4 | 0.3 | ⊚ | 92.8 | ◯ | ◯ | 3H |
| Example 5 | 0.4 | ⊚ | 92.0 | ◯ | ◯ | 3H |
| Example 6 | 0.4 | ⊚ | 90.2 | ◯ | ◯ | 3H |
| Example 7 | 0.3 | ⊚ | 92.2 | ◯ | ◯ | 3H |
| Example 8 | 0.3 | ⊚ | 91.7 | ◯ | ◯ | 3H |
| Example 9 | 0.5 | ⊚ | 92.1 | ◯ | ◯ | 3H |
| Comparative | 0.3 | ⊚ | 92.1 | ◯ | X | 3H |
| example 1 | | | | | | |
| Comparative | 1.8 | X | 91.5 | ◯ | ◯ | 2H |
| example 2 | | | | | | |
| Comparative | 0.3 | ⊚ | 92.1 | ◯ | X | 3H |
| example 3 | | | | | | |
| Comparative | 0.4 | ⊚ | 92.1 | ◯ | X | 3H |
| example 4 | | | | | | |
| Comparative | 11.0 | X | 90.8 | ◯ | ◯ | 2H |
| example 5 | | | | | | |
| Comparative | 18.3 | X | 85.3 | X | ◯ | H |
| example 6 | | | | | | |
| Comparative | 0.3 | ⊚ | 92.1 | ◯ | X | 3H |
| example 7 | | | | | | |
| Comparative | 1.3 | X | 89.0 | X | X | 2H |
| example 8 | | | | | | |
| Comparative | 0.4 | ⊚ | 91.6 | ◯ | ◯ | HB |
| example 9 | | | | | | |
| Comparative | 0.4 | ⊚ | 91.0 | ◯ | X | H |
| example 10 | | | | | | |
| Comparative | 3.0 | X | 91.5 | ◯ | X | 2H |
| example 11 | | | | | | |
| Comparative | 0.2 | ⊚ | 93.0 | ◯ | ◯ | H |
| example 12 | | | | | | |
| Comparative | 0.2 | ⊚ | 93.0 | ◯ | ◯ | H |
| example 13 | | | | | | |
| Comparative | 0.2 | ⊚ | 93.0 | ◯ | ◯ | H |
| example 14 | | | | | | |
| Comparative | 0.2 | ⊚ | 92.4 | ◯ | X | 2H |
| example 15 | | | | | | |
| Comparative | 1.3 | X | 91.5 | ◯ | ◯ | 2H |
| example 16 | | | | | | |

### (Summary of Results)

As shown in Tables 1 and 2, the HC films obtained in Examples 1 to 9 have sufficient anti-blocking property and excellent haze and total light transmittance.

However, in Comparative example 1, wherein the content of the slipping agent (B) is low, the anti-blocking property is insufficient while the haze and the total light transmittance are excellent.

In Comparative example 2, wherein the content of the slipping agent (B) is high, the haze is high and the pencil hardness is low while the anti-blocking property is sufficient.

In Comparative examples 3 and 4, wherein the slipping agent (B) has small average primary particle diameter, the anti-blocking property is insufficient while the haze and the total light transmittance are excellent.

In Comparative example 5, wherein the slipping agent (B) has large average primary particle diameter, the haze is high and the pencil hardness is low while the anti-blocking property is sufficient.

In Comparative example 6, wherein the slipping agent (B) has large average primary particle diameter, the evaluations of haze, total light transmittance and pencil hardness are not good while the anti-blocking property is sufficient.

In Comparative example 7, wherein the secondary particle (C) has small average secondary particle diameter, the anti-blocking property is insufficient while the haze and the total light transmittance are excellent.

In Comparative example 8, wherein the reactive silica particle (A) has large average primary particle diameter, the haze is high and the total light transmittance is low.

In Comparative example 9, wherein the monofunctional monomer is used instead of the multifunctional monomer (D), the pencil hardness is low.

In Comparative example 10, wherein the binder having large molecular weight is used instead of the multifunctional monomer (D), the anti-blocking property is insufficient and the pencil hardness is low.

In Comparative example 11, wherein a PET substrate is used as the substrate, the anti-blocking property is insufficient, the haze is high and the pencil hardness is low.

In Comparative example 12, wherein the reactive silica (A) and the slipping agent (B) are not added, the pencil hardness is low.

In Comparative examples 13 and 14, wherein the content of the reactive silica (A) is not within the range of the present invention, the pencil hardness is low.

In Comparative example 15, wherein the content of the slipping agent (B) is less than the range of the present invention, the anti-blocking property is insufficient and the pencil hardness is low.

In Comparative example 16, wherein the content of the slipping agent (B) is more than the range of the present invention, the haze is high and the pencil hardness is low.

When a hard coat film was produced similarly as Example 1 using an ink (the secondary particle diameter is over 4,000 nm), which is the curable resin composition for the hard coat layer prepared in Example 1 but left for 36 hours after preparation, the haze was 20 and the pencil hardness was H, and an excellent hard coat film was not obtained.

When a curable resin composition for a hard coat layer was prepared unlike the steps (1), (2) and (3) in Example 1 but by simultaneously mixing all the same material by the same mass, the secondary particle diameter was less than 200 nm, and a three-components-aggregated secondary particle was not formed. When a hard coat film was produced with this ink, the anti-blocking property was not obtained at all.

### REFERENCE SIGNS LIST

1: Hard coat film
10: Triacetyl cellulose substrate
20: Hard coat layer
30: Low refractive index layer
40: Protecting film
50: Polarizing layer
60: Polarizer
70: Polarizing plate

1. A curable resin composition for a hard coat layer comprising:
(A) a reactive silica particle having a photocurable group on a surface of the particle and an average primary particle diameter of 10 to 100 nm,
(B) a slipping agent having an average primary particle diameter of 100 to 300 nm,
(C) a secondary particle at least comprising the slipping agent (B) and having an average secondary particle diameter of 500 to 2,000 nm,
(D) a multifunctional monomer having, in a molecule, two or more reactive functional groups crosslinkable with the photocurable group of the reactive silica particle (A) and having a molecular weight of 1,000 or less, and
(E) a solvent,
wherein the resin composition contains no secondary particle having an average secondary particle diameter of more than 2,000 nm, and contains 0.2 to 8% by mass of the slipping agent (B) with respect to the total mass of the reactive silica particle (A) and the multifunctional monomer (D).

2. The curable resin composition for a hard coat layer according to claim 1, wherein the secondary particle (C) contains a three-components-aggregated secondary particle, in which at least the reactive silica particle (A), the slipping agent (B) and the multifunctional monomer (D) are aggregated.

3. The curable resin composition for a hard coat layer according to claim 1, wherein the solvent (E) is at least one kind selected from the group consisting of methyl acetate, ethyl acetate, butyl acetate, methyl ethyl ketone, methyl isobutyl ketone and cyclohexanone.

4. A method for producing a hard coat film comprising the steps of:
(i) applying the curable resin composition for a hard coat layer defined by claim 1 on a triacetyl cellulose substrate to form a coating layer, and
(ii) curing the coating layer by light irradiation to form the hard coat layer.

5. The method for producing a hard coat film according to claim 4, the curable resin composition for the hard coat layer is prepared according to the steps of:
(1) mixing a composition comprising at least the reactive silica particle (A), the multifunctional monomer (D) and the solvent (E) to prepare Ink 1,
(2) mixing a composition comprising at least the slipping agent (B) and the solvent (E) to prepare Ink 2, and
(3) forming the secondary particle (C) by gradually mixing said Ink 2 into said Ink 1 while stirring said Ink 1 to prepare the curable resin composition for the hard coat layer.

6. The method for producing a hard coat film according to claim 4, wherein the curable resin composition for the hard coat layer is applied on the substrate within 24 hours after completing preparation of the curable resin composition.

7. A hard coat film produced by the method defined by claim 4.

8. A polarizing plate comprising the hard coat film defined in claim 7, and a polarizer provided on a triacetyl cellulose substrate side of the hard coat film.

9. A display panel comprising the hard coat film defined in claim 7, and a display provided on a triacetyl cellulose substrate side of the hard coat film.
